(19) United States
(12) Patent Application Publication
(10) Pub. No.: US 2025/0145445 A1
(43) Pub. Date: May 8, 2025

(54) ELECTRONIC DEVICE FOR PERFORMING WATER DISCHARGE OPERATION BY INTERWORKING WITH EXTERNAL TERMINAL, AND CONTROL METHOD THEREOF

(71) Applicant: SAMSUNG ELECTRONICS CO., LTD., Suwon-si (KR)

(72) Inventor: Sanghoon HAN, Suwon-si (KR)

(73) Assignee: SAMSUNG ELECTRONICS CO., LTD., Suwon-si (KR)

(21) Appl. No.: 19/016,621

(22) Filed: Jan. 10, 2025

Related U.S. Application Data
(63) Continuation of application No. PCT/KR2023/009576, filed on Jul. 6, 2023.

(30) Foreign Application Priority Data
Aug. 23, 2022 (KR) 10-2022-0105454

(51) Int. Cl. B67D 1/08; B67D 1/00

(52) U.S. Cl. CPC B67D 1/0888; B67D 1/0014

(57) ABSTRACT

An electronic device including a communication interface for communicating with an external terminal; a water discharge unit that discharges water; an input unit that receives an input of a water discharge command; and at least one processor. The at least one processor performs processing to: receive water discharge limit information from the terminal via the communication interface; determine, on a basis of the water discharge limit information, whether, when a water discharge command is input via the input unit, the water discharge command corresponds to a command limiting water discharge; perform user authentication if the water discharge command corresponds to a command limiting water discharge; and control the water discharge unit to perform a water discharge operation in response to the water discharge command if the user authentication is successful.

### CROSS-REFERENCE TO RELATED APPLICATIONS

This application is a continuation of International Application No. PCT/KR2023/009576, filed Jul. 6, 2023, and claims foreign priority to Korean Application No. 10-2022-0105454, filed Aug. 23, 2022, which are incorporated herein by reference herein in their entireties.

### TECHNICAL FIELD

The disclosure relates to an electronic device and a control method thereof, and more particularly, to an electronic device that performs a water discharge operation by interworking with an external terminal, and a control method thereof.

### BACKGROUND ART

An electronic device such as a water purifier can provide drinking water to a user as it removes harmful substances included in raw water such as tap water or underground water through various water purification methods such as precipitation, filtration, and sterilization, etc. An electronic device such as a water purifier is provided to supply clean water to a user as one or more water purifying filters filter water that was introduced.

In particular, an electronic device such as a water purifier is a product that can discharge purified water such as purified water, cold water, hot water, etc., and is thus a product posing high risk of burn because of water leak and a water heating operation due to water. In the past, a malfunction in control was prevented by providing a button such as safety lock or kids lock as a function for reducing such risk. That is, in a water purifier, a separate lock button is provided, and unwanted control is prevented by activating or inactivating authority to perform control in case a user presses the lock button for a long time or for a short time.

### DISCLOSURE

### Technical Solution

An electronic device configured to perform a water discharge operation by interworking with an external terminal according to an embodiment of the disclosure includes a main body, a communication interface configured to perform communication with an external terminal, a water discharge part that is coupled with the main body, and is in communication with the inside of the main body, an input part that is provided on the main body and receives an input of a water discharge command, memory, and at least one processor configured to receive water discharge limit information from the terminal through the communication interface and store the water discharge limit information in the memory, and based on receiving an input of a water discharge command through the input part, determine whether the water discharge command corresponds to a command limiting water discharge on the basis of the water discharge limit information, and based on the water discharge command corresponding to the command limiting water discharge, perform user authentication, and based on the user authentication succeeding, control the water discharge part to perform a water discharge operation in response to the water discharge command.

A control method of an electronic device configured to perform a water discharge operation by interworking with an external terminal according to an embodiment of the disclosure includes the steps of receiving water discharge limit information from the terminal, and based on receiving an input of a water discharge command, determining whether the water discharge command corresponds to a command limiting water discharge on the basis of the received water discharge limit information, and based on the water discharge command corresponding to the command limiting water discharge, performing user authentication, and based on the user authentication succeeding, performing a water discharge operation in response to the water discharge command.

In a computer-readable medium including a program for executing a control method of an electronic device configured to perform a water discharge operation by interworking with an external terminal according to an embodiment of the disclosure, the control method includes the steps of receiving water discharge limit information from the terminal, and based on receiving an input of a water discharge command, determining whether the water discharge command corresponds to a command limiting water discharge on the basis of the received water discharge limit information, and based on the water discharge command corresponding to the command limiting water discharge, performing user authentication, and based on the user authentication succeeding, performing a water discharge operation in response to the water discharge command.

An electronic device according to an embodiment of the disclosure includes a communication interface configured to perform communication with an external terminal, a water discharge part configured to discharge water, an input part configured to receive an input of a water discharge command, and at least one processor configured to perform processing to (a) receive water discharge limit information from the terminal through the communication interface, (b) based on receiving an input of a water discharge command through the input part, determine whether the water discharge command corresponds to a command limiting water discharge on a basis of the water discharge limit information, (c) based on the water discharge command corresponding to the command limiting water discharge, perform user authentication, and (d) based on the user authentication succeeding, control the water discharge part to perform a water discharge operation in response to the water discharge command.

A control method of an electronic device according to an embodiment of the disclosure includes (a) receiving water discharge limit information from an external terminal, (b) based on receiving an input of a water discharge command, determining whether the water discharge command corresponds to a command limiting water discharge on a basis of the received water discharge limit information, (c) based on the water discharge command corresponding to the command limiting water discharge, performing user authentication, and (d) based on the user authentication succeeding, performing a water discharge operation in response to the water discharge command.

### DESCRIPTION OF DRAWINGS

FIG. 1 is a diagram illustrating a system providing a water discharge limiting function by using an electronic device and a terminal according to an embodiment of the disclosure;

FIG. 2A is a block diagram including components of an electronic device according to an embodiment of the disclosure;

FIG. 2B is a diagram illustrating an exterior of an electronic device according to an embodiment of the disclosure;

FIG. 3 is a block diagram illustrating components for performing a water discharge limiting function according to an embodiment of the disclosure;

FIG. 4 is a sequence diagram for illustrating a method of providing a water discharge limiting function by using an electronic device and a terminal according to an embodiment of the disclosure;

FIG. 5 is a flow chart for illustrating a method of providing a water discharge limiting function of an electronic device according to an embodiment of the disclosure;

FIG. 6 is a diagram illustrating a user authentication screen displayed on a terminal according to an embodiment of the disclosure;

FIG. 7 is a flow chart for illustrating a control method of an electronic device that is in communication with an external terminal and performs a water discharge operation according to an embodiment of the disclosure; and

FIG. 8 is a block diagram including components of a terminal according to an embodiment of the disclosure.

### MODE FOR INVENTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used just to explain specific embodiments of the disclosure, and are not intended to limit the scope of the disclosure. Also, singular expressions include plural expressions, unless defined obviously differently in the context.

Also, in the disclosure, expressions such as “have,” “may have,” “include,” and “may include” denote the existence of such characteristics (e.g.: elements such as numbers, functions, operations, and components), and do not exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another clement (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

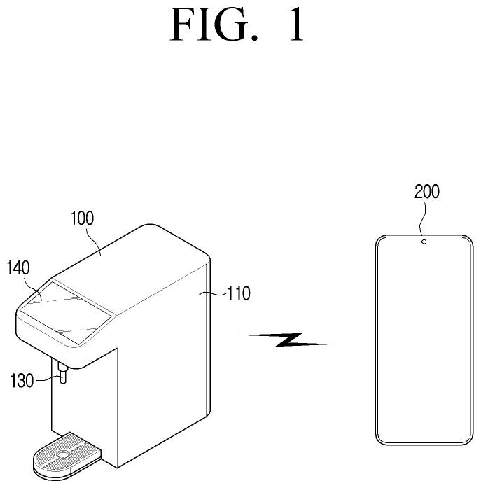

FIG. 1 is a diagram illustrating a system providing a water discharge limiting function by using an electronic device and a terminal according to an embodiment of the disclosure. As illustrated in FIG. 1, the electronic device 100 may be implemented as a water purifier, but this is merely an example, and the electronic device 100 may be implemented as various electronic devices such as a refrigerator, a coffee machine, etc. providing a water discharge function. Also, the terminal 200 may be implemented as a smartphone, but this is merely an example, and the terminal 200 may be implemented as various user terminals such as a tablet PC, a laptop PC, etc.

The electronic device 100 and the terminal 200 may be communicatively connected with each other. The terminal 200 may remotely control the electronic device 100.

In particular, the terminal 200 may receive an input of water discharge limit information through an application for controlling the electronic device 100. Here, the water discharge limit information may include at least one of information on a water discharge limit time, information on a water discharge mode for which a water discharge limit was set by a user among a plurality of water discharge modes, or information on a temperature of water of which discharge is limited, which was set by the user.

The terminal 200 may transmit the water discharge limit information set by the user to the electronic device 100. The electronic device 100 may store the received water discharge limit information.

The electronic device 100 may receive an input of a water discharge command. Here, the water discharge command may include information on a water discharge mode by which the user wishes to discharge water, a temperature of water, and an amount of water.

When a water discharge command is input, the electronic device 100 may determine whether the water discharge command corresponds to a command limiting water discharge on the basis of the stored water discharge limit information.

If the water discharge command does not correspond to a command limiting water discharge, the electronic device 100 may perform a water discharge operation according to the water discharge command. However, if the water discharge command corresponds to a command limiting water discharge, the electronic device 100 may perform user authentication. In particular, the electronic device 100 may request user authentication to the terminal 200.

When user authentication succeeds through the terminal 200, the terminal 200 may transmit the result of the user authentication to the electronic device 100. The electronic device 100 may perform a water discharge operation corresponding to the water discharge command according to the result of the user authentication.

As described above, by fundamentally preventing an unintended operation of the electronic device 100 by a child, an elderly person, a pet, etc. by setting the water discharge limit information through the external terminal 200, risk of burn when using hot water and damage that may occur because of water leak due to an input of a water discharge key in the absence of the user can be removed.

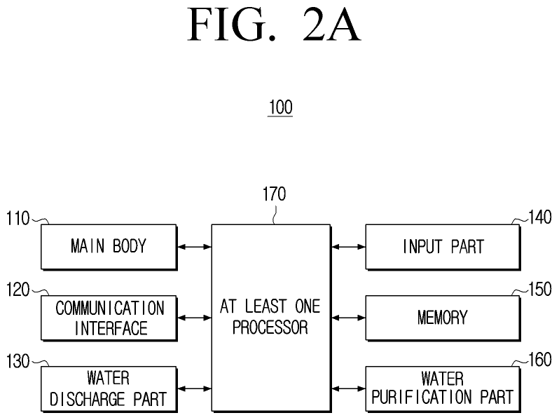

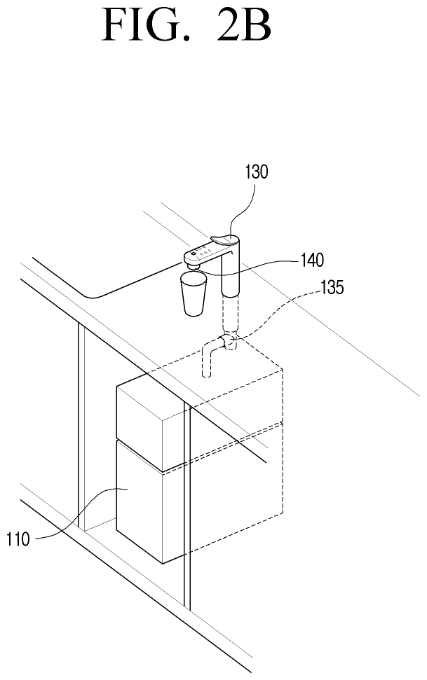

FIG. 2A is a block diagram including components of an electronic device according to an embodiment of the disclosure. As illustrated in FIG. 2A, the electronic device 100 may include a main body 110, a communication interface 120, a water discharge part 130, an input part 140, memory 150, and a water purification part 160. However, this is merely an example, and some of the aforementioned components may be omitted according to the type of the electronic device 100, and other components may be added.

The main body 110 may house other components (e.g., the communication interface 120, the memory 150, the water purification part 160, etc.). In particular, the main body 110 may be provided with raw water such as tap water through an external pipe, and purify the raw water by the water purification part 160, and may be connected with the water discharge part 130 and provide water according to a water discharge command (e.g., cold water, hot water, purified water, etc.) to the water purification part 130.

The communication interface 120 is a component that performs communication with various types of external devices according to various types of communication methods. The communication interface 120 may include a wireless communication module or a wired communication module. Here, each communication module may be implemented in a form of at least one hardware chip. A wireless communication module may be a module that communicates with an external device wirelessly. For example, a wireless communication module may include at least one module among a Wi-Fi module, a Bluetooth module, an infrared communication module, or other communication modules (e.g., Long Term Evolution (LTE), LTE Advanced (LTE-A), 4th Generation (4G), 5th Generation (5G)).

In particular, the communication interface 120 may perform communication with the external terminal 200. The communication interface 120 may receive water discharge limit information from the terminal 200. Also, the communication interface 120 may transmit a request of user authentication to the terminal 200, and receive information on the result of the user authentication from the terminal 200.

The water discharge part 130 may discharge water provided from the main body 110 to the outside according to a water discharge command. According to an embodiment of the disclosure, the water discharge part 130 may be implemented in a form of a cock having a water discharge outlet, as illustrated in FIG. 1. Here, the water discharge part 130 may further include a manipulation lever that can open or close the water discharge outlet. When the manipulation lever is pushed, water may come out, and when the manipulation lever is restored, water may be blocked.

According to an embodiment of the disclosure, the water discharge part 130 may be implemented in a form of a faucet arranged in the upper part of a kitchen worktop (e.g., a sink), as illustrated in FIG. 2B. Here, the water discharge part 130 may be rotatably installed in the upper part of the kitchen worktop. Also, the water discharge part 130 may be connected with the main body 110 through a connecting element 135. Here, the main body 110 may be arranged in the lower part of the kitchen worktop, as illustrated in FIG. 2B.

The input part 140 may receive an input of a user command for water discharge (referred to as “a water discharge command” hereinafter). According to an embodiment, as illustrated in FIG. 1, the input part 140 may be implemented in forms of a plurality of keys (or buttons) on one side of the main body 110. Here, the plurality of keys may correspond to a plurality of water discharge modes (e.g., a cold water discharge mode, a hot water discharge mode, a purified water discharge mode, etc.). Alternatively, as illustrated in FIG. 1, the input part 140 may be implemented in a form of a manipulation lever arranged on the rear side of the water discharge part 130. Alternatively, as illustrated in FIG. 2B, the input part 140 may be implemented in a form of a touch button on one side of the water discharge part 130. In particular, a water discharge command may include information on a water discharge mode by which the user wishes to discharge water (e.g., a cold water discharge mode, a hot water discharge mode, a purified water discharge mode, an ice water discharge mode, etc.), a temperature of water, and an amount of water.

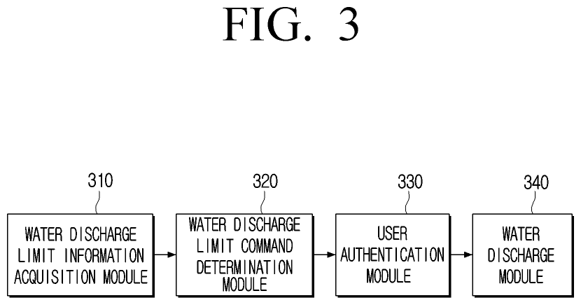

The memory 150 may store at least one instruction for controlling the electronic device 100. In particular, the memory 150 may store data that is necessary for a module for performing the water discharge limiting function to perform various types of operations. The module for providing the water discharge limiting function may include a water discharge limit information acquisition module 310, a water discharge limit command determination module 320, a user authentication module 330, and a water discharge module 340 as illustrated in FIG. 3.

Meanwhile, the memory 150 may include non-volatile memory that can maintain the stored information even if power supply is stopped, and volatile memory that needs constant power supply for maintaining the stored information. The module for providing the water discharge limiting function may be stored in the non-volatile memory.

The water purification part 160 may include at least one filter for providing purified water. Also, the water purification part 160 may include a heat exchange unit that is provided to cool or heat water purified by the at least one filter. Here, the water purification part 160 may include a refrigeration cycle device including a heat exchange unit compressor, a condenser, an expansion valve, and an evaporator, and a heater.

The water purification part 160 may generate purified water according to a water discharge mode corresponding to a water discharge command, the temperature of water, and the amount of water. Then, the water purification part 160 may provide the generated purified water to the water discharge part 130.

The at least one processor 170 may be electrically connected with the memory 150, and control the overall functions and operations of the electronic device 100. When an event for providing the water discharge limiting function (e.g., an event wherein an application is executed by the terminal 200, an event wherein water discharge limit information is received from the terminal 200, etc.) is detected, the at least one processor 170 may load data for the module for providing the water discharge limiting function stored in the non-volatile memory to perform various types of operations on the volatile memory. The at least one processor 170 may perform various types of operations by using various types of modules based on the data loaded on the volatile memory. Here, loading means an operation of calling the data stored in the non-volatile memory to the volatile memory and storing the data, so that the at least one processor 170 can access the data.

In particular, the at least one processor 170 may control the overall operations of the electronic device 100 by executing at least one instruction stored in the memory 150. Specifically, the at least one processor 170 receives water discharge limit information from the terminal 200 through the communication interface 120, and stores the water discharge limit information in the memory 150. When a water discharge command is input through the input part 140, the at least one processor 170 determines whether the water discharge command corresponds to a command limiting water discharge based on the water discharge limit information. If the water discharge command corresponds to a command limiting water discharge, the at least one processor 170 performs user authentication. If the user authentication succeeds, the at least one processor 170 controls the water discharge part 130 to perform a water discharge operation in response to the water discharge command.

Specifically, the water discharge limit information may include information on the water discharge limit time. Here, the at least one processor 170 may determine whether the water discharge command corresponds to the command limiting water discharge by determining whether the time when the water discharge command was input corresponds to the water discharge limit time.

Also, the water discharge limit information may include information on a water discharge mode for which a water discharge limit was set by the user among a plurality of water discharge modes. Here, the plurality of water discharge modes may include at least two of a purified water discharge mode, a cold water discharge mode, a hot water discharge mode, or an ice water discharge mode. The at least one processor 170 may determine whether the water discharge command corresponds to the command limiting water discharge by determining whether the water discharge mode selected by the water discharge command corresponds to the water discharge mode for which the water discharge limit was set.

Also, the water discharge limit information may include information on the temperature of water of which discharge is limited, which was set by the user. In particular, in case the water discharge mode selected by the user is a hot water mode, the water discharge limit information may include information on the temperature of hot water of which discharge is limited, which was set by the user. The at least one processor 170 may determine whether the water discharge command corresponds to the command limiting water discharge by comparing the temperature of water selected by the water discharge command and the temperature of the water of which discharge is limited, which was set by the user.

In addition, the at least one processor 170 may control the communication interface 120 to transmit a signal requesting user authentication to the terminal 200. When the user authentication is performed in the terminal device 200 in response to the signal, the at least one processor 170 may receive information on the result of the user authentication from the terminal 200 through the communication interface 120. As described above, as user authentication is performed through the external terminal 200, user authentication can be performed without a separate authentication part in the electronic device 100.

Further, in case the electronic device 100 includes at least one of a fingerprint authentication part or a password authentication part, the at least one processor 170 may perform user authentication through at least one of the fingerprint authentication part or the password authentication part included in the electronic device 100.

Also, when the user authentication fails, the at least one processor 170 may ignore the water discharge command, and may not perform a water discharge operation.

FIG. 3 is a block diagram illustrating components for performing a water discharge limiting function according to an embodiment of the disclosure. The electronic device 100 may include a water discharge limit information acquisition module 310, a water discharge limit command determination module 320, a user authentication module 330, and a water discharge module 340. Here, the plurality of modules 310 to 340 may be implemented as software, but this is merely an example, and the plurality of modules 310 to 340 may be implemented in a form wherein software and hardware are combined.

The water discharge limit information acquisition module 310 may obtain water discharge limit information. Specifically, the water discharge limit information acquisition module 310 may obtain water discharge limit information from the external terminal 200. Here, the water discharge limit information may include at least one of information on a water discharge limit time, information on a water discharge mode for which a water discharge limit was set by the user among a plurality of water discharge modes, or information on a temperature of water of which discharge is limited, which was set by the user. However, this is merely an example, and the water discharge limit information may further include information on the amount of water of which discharge is limited by the user, etc.

Also, the water discharge limit information acquisition module 310 may obtain water discharge limit information from the external terminal 200, but this is merely an example, and the water discharge limit information acquisition module 310 may obtain water discharge limit information through the input part 140 of the electronic device 100.

The water discharge limit command determination module 320 may determine whether a water discharge command corresponds to a command limiting water discharge. Specifically, in case information on the water discharge limit time is included in the water discharge limit information, the water discharge limit command determination module 320 may determine whether the water discharge command corresponds to a command limiting water discharge by determining whether the time when the water discharge command was input corresponds to the water discharge limit time. For example, in case the water discharge limit information includes information that “water discharge is limited from 9 a.m. to 6 p.m.,” the water discharge limit command determination module 320 may determine whether the water discharge command corresponds to a command limiting water discharge by determining whether the time when the water discharge command was input corresponds to a time between 9 a.m. to 6 p.m.

Also, in case the water discharge limit information includes information on a water discharge mode for which a water discharge limit was set by the user among the plurality of water discharge modes, the water discharge limit command determination module 320 may determine whether the water discharge command corresponds to a command limiting water discharge by determining whether the water discharge mode selected by the water discharge command corresponds to a water discharge mode for which a water discharge limit was set. For example, in case information that “discharge of hot water is limited” is included in the water discharge limit information, the water discharge limit command determination module 320 may determine whether the water discharge command corresponds to a command limiting water discharge by determining whether the water discharge mode selected by the water discharge command is a hot water discharge mode.

In addition, in case the water discharge limit information includes information on the temperature of water of which discharge is limited, which was set by the user, the water discharge limit command determination module 320 may determine whether the water discharge command corresponds to a command limiting water discharge by comparing the temperature of water selected by the water discharge command and the temperature of the water of which discharge is limited, which was set by the user. For example, in case the water discharge limit information includes information that “discharge of hot water of 70° C. or higher is limited,” the water discharge limit command determination module 320 may determine whether the water discharge mode corresponds to a command limiting water discharge by determining whether the temperature of the water selected by the water discharge command is 70° C. or higher.

Further, in case the water discharge limit information includes information on the amount of water of which discharge is limited, which was set by the user, the water discharge limit command determination module 320 may determine whether the water discharge command corresponds to a command limiting water discharge by comparing the amount of water selected by the water discharge command and the amount of the water of which discharge is limited, which was set by the user. For example, in case the water discharge limit information includes information that “water discharge of 600 ml or more is limited,” the water discharge limit command determination module 320 may determine whether the water discharge command corresponds to a command limiting water discharge by determining whether the amount of the water selected by the water discharge command is 600 ml or more.

The user authentication module 330 may perform user authentication in a situation wherein water discharge is limited. Specifically, in case it was determined that a water discharge command corresponds to a command limiting water discharge, the user authentication module 330 may output a message guiding that user authentication is needed to the user. Then, the user authentication module 330 may transmit a signal requesting user authentication to the external terminal 200. Here, the signal requesting user authentication may include information on the water discharge command (e.g., the water discharge mode selected by the user, the temperature of water, the amount of water, etc.).

The user authentication module 330 may receive the result for the user authentication from the terminal 200. For example, in case the user performed user authentication through the terminal 200, the user authentication module 330 may receive information on success of the user authentication from the terminal 200. In case the user rejects user authentication through the terminal 200 or does not input a response for the user authentication during a predetermined time, the user authentication module 330 may receive information on failure of the user authentication from the terminal 200.

Also, the user authentication module 330 may perform user authentication through at least one of a fingerprint authentication part or a password authentication part provided in the electronic device 100. In case it was determined that a water discharge command corresponds to a command limiting water discharge, the user authentication module 330 may output a message guiding that user authentication is needed to the user. Then, when a user input is received through at least one of the fingerprint authentication part or the password authentication part, the user authentication module 330 may perform user authentication according to the result of the user input.

The water discharge module 340 may perform a water discharge operation according to a water discharge command. In particular, in case it was determined that a water discharge command is not a command limiting water discharge, or in case it was determined that a water discharge command is a command limiting water discharge, but user authentication succeeded, the water discharge module 340 may perform a water discharge operation according to the water discharge command. In particular, the water discharge module 340 may perform a water discharge operation according to the water discharge mode selected by the water discharge command, the temperature of water, and the amount of water.

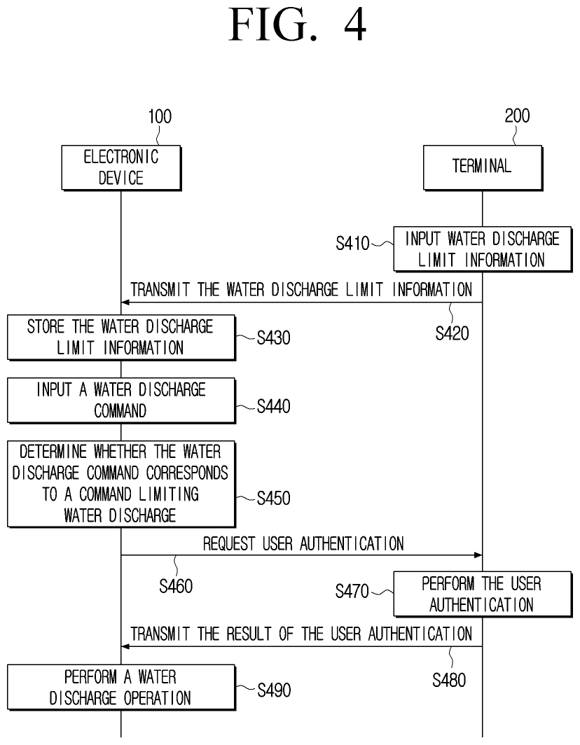

FIG. 4 is a sequence diagram for illustrating a method of providing a water discharge limiting function by using an electronic device and a terminal according to an embodiment of the disclosure.

The terminal 200 may receive an input of water discharge limit information in operation S410. Specifically, the terminal 200 may receive an input of water discharge limit information based on a user input that was input on the screen of an application for controlling the electronic device 100.

The terminal 200 may transmit the input water discharge limit information to the electronic device 100 in operation S420.

The electronic device 100 may store the received water discharge limit information in operation S430.

The electronic device 100 may receive an input of a water discharge command in operation S440. For example, if one of a plurality of keys included in the electronic device 100 is selected, the electronic device 100 may receive an input of a water discharge command according to the selected key. The water discharge command may include information on the water discharge mode selected by the user, the temperature of water, and the amount of water.

The electronic device 100 may determine whether the water discharge command is a command limiting water discharge in operation S450. Specifically, the electronic device 100 may determine whether the water discharge command is a command limiting water discharge based on pre-stored water discharge limit information. For example, the electronic device 100 may determine whether the water discharge command is a command limiting water discharge by determining whether the time when the water discharge command was input corresponds to a water discharge limit time. Also, the electronic device 100 may determine whether the water discharge command corresponds to a command limiting water discharge by determining whether the water discharge mode selected by the water discharge command corresponds to a water discharge mode for which a water discharge limit was set. In addition, the electronic device 100 may determine whether the water discharge command corresponds to a command limiting water discharge by comparing the temperature of water selected by the water discharge command and the temperature of water of which discharge is limited, which was set by the user.

If the water discharge command is determined as a command limiting water discharge, the electronic device 100 may request user authentication to the terminal 200 in operation S460. Here, the electronic device 100 may transmit information on the water discharge command together with a signal requesting user authentication.

The terminal 200 may perform user authentication in operation S470. Here, on the terminal 200, a screen requesting authentication may be displayed on the screen of the application for controlling the electronic device 100. Then, the terminal device 200 may perform user authentication according to a user input that was input into the screen requesting authentication. Here, the terminal 200 may perform user authentication through various authentication methods such as fingerprint authentication, password authentication, iris authentication, etc.

The terminal 200 may transmit the result of authentication to the electronic device 100 in operation S480.

The electronic device 100 may perform a water discharge operation based on the result of authentication in operation S490. Specifically, if user authentication succeeds, the electronic device 100 may perform a water discharge operation according to the water discharge command.

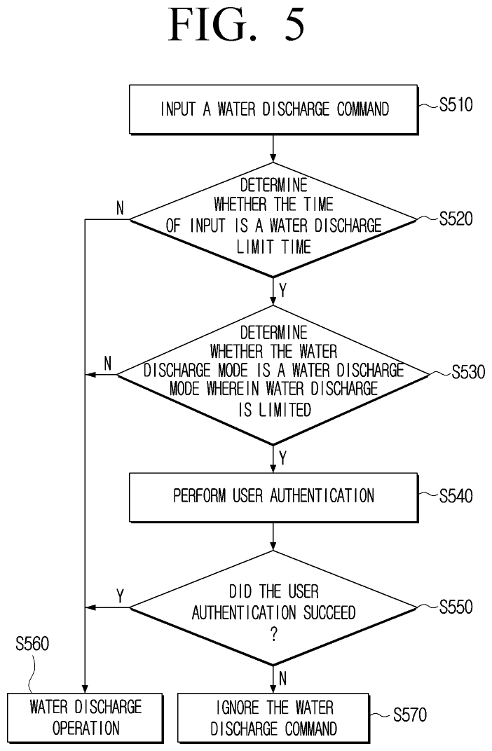

FIG. 5 is a flow chart for illustrating a method of providing a water discharge limiting function of an electronic device according to an embodiment of the disclosure.

The electronic device 100 may receive an input of a water discharge command in operation S510. For example, the electronic device 100 may receive an input of a water discharge command for manipulating a key or a manipulation lever provided on the electronic device 100.

The electronic device 100 may determine whether the time when the water discharge command was input is the water discharge limit time in operation S520. For example, in case the water discharge limit time stored in the water discharge limit information is 9 a.m. to 6 p.m., the electronic device 100 may determine whether the time when the water discharge command was input is between 9 a.m. and 6 p.m. which is the water discharge limit time.

If it is determined that the time of input is not the water discharge limit time in operation S520-N, the electronic device 100 may perform a water discharge operation according to the water discharge command in operation S560. For example, in case the time when the water discharge command was input is 8 p.m., the electronic device 100 may determine that the time when the water discharge command was input is not the water discharge limit time, and perform a water discharge operation according to the water discharge command.

If it is determined that the time of input is the water discharge limit time in operation S520-Y, the electronic device 100 may determine whether the water discharge mode selected by the water discharge command is a water discharge mode wherein water discharge is limited in operation S530. For example, in case the time when the water discharge command was input is 2 p.m., the electronic device 100 may determine that the time when the water discharge command was input is the water discharge limit time, and determine whether the currently selected water discharge mode is a hot water mode which is a water discharge mode wherein water discharge is limited.

If it is determined that the selected water discharge mode is not a water discharge mode wherein water discharge is limited in operation S530-N, the electronic device 100 may perform a water discharge operation according to the water discharge command in operation S560. For example, in case the selected water discharge mode is a cold water mode, the electronic device 100 may determine that the selected water discharge mode is not a water discharge mode wherein water discharge is limited, and perform a water discharge operation according to the water discharge command.

If it is determined that the selected water discharge mode is a water discharge mode wherein water discharge is limited in operation S530-Y, the electronic device 100 may perform user authentication in operation S540. For example, in case the selected water discharge mode is a hot water mode, the electronic device 100 may determine that the selected water discharge mode is a hot water mode which is a water discharge mode wherein water discharge is limited, and perform user authentication.

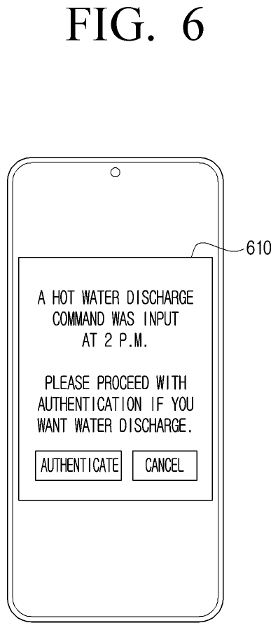

In particular, for performing user authentication, the electronic device 100 may transmit a signal requesting user authentication to the terminal 200. The terminal 200 may display a user authentication screen as illustrated in FIG. 6 in response to the signal requesting user authentication. The user authentication screen may include a message including information on the water discharge command and a request for user authentication. For example, as illustrated in FIG. 6, the user authentication screen may include a message 610 which is “A hot water discharge command was input at 2 p.m. Please proceed with authentication if you want water discharge.” Here, if the authentication icon is selected, the terminal 200 may display a fingerprint authentication screen or a password authentication screen. When user authentication is performed through the fingerprint authentication screen or the password authentication screen, the terminal 200 may transmit the result of the user authentication to the electronic device 100.

The electronic device 100 may determine whether the user authentication succeeded in operation S550.

If the user authentication succeeded in operation S550-Y, the electronic device 100 may perform a water discharge operation according to the water discharge command in operation S560. If the user authentication failed in operation S550-N, the electronic device 100 may ignore the water discharge command in operation S570. That is, the electronic device 100 may ignore the water discharge command according to failure of the user authentication, and may not perform a water discharge operation. Also, in case the user authentication failed, the electronic device 100 may store information on the water discharge command or information on the failure of the user authentication, or transmit the information to the terminal 200.

Meanwhile, in FIG. 5, it was explained that the electronic device 100 sequentially determines whether a water discharge command corresponds to a water discharge limit time or a water discharge limit mode, but this is merely an example, and the electronic device 100 may perform in parallel an operation of determining whether a water discharge command corresponds to a water discharge limit time and an operation of determining whether a water discharge command corresponds to a water discharge limit mode. Other than the above, the electronic device 100 can obviously further determine whether the temperature of water selected by a water discharge command is the temperature of water of which discharge is limited, and whether the amount of water selected by a water discharge command is the amount of water of which discharge is limited.

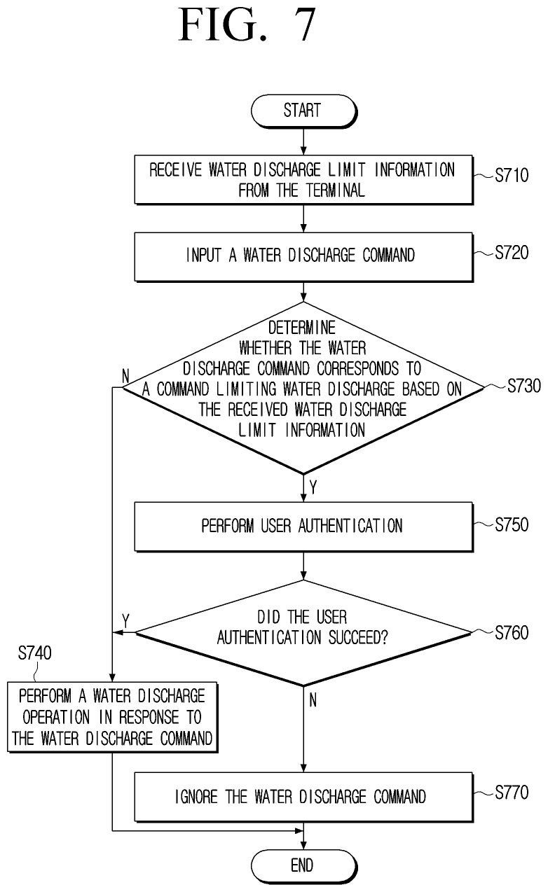

FIG. 7 is a flow chart for illustrating a control method of an electronic device that is in communication with an external terminal and performs a water discharge operation according to an embodiment of the disclosure.

The electronic device 100 receives water discharge limit information from the terminal 200 in operation S710. Then, the electronic device 100 may store the water discharge limit information. The water discharge limit information may include at least one of information on a water discharge limit time, information on a water discharge mode for which a water discharge limit was set by a user among a plurality of water discharge modes, or information on a temperature of water of which discharge is limited, which was set by the user.

The electronic device 100 receives an input of a water discharge command in operation S720. Specifically, the electronic device 100 may receive an input of a water discharge command for touching a plurality of keys corresponding to the plurality of water discharge modes.

The electronic device 100 determines whether the water discharge command corresponds to a command limiting water discharge on the basis of the received water discharge limit information in operation S730. Specifically, the electronic device 100 may determine whether the water discharge command corresponds to the command limiting water discharge by determining whether the time when the water discharge command was input corresponds to the water discharge limit time. Alternatively, the electronic device 100 may determine whether the water discharge command corresponds to a command limiting water discharge by determining whether the water discharge mode selected by the water discharge command corresponds to a water discharge mode for which a water discharge limit was set. Alternatively, the electronic device 100 may determine whether the water discharge command corresponds to a command limiting water discharge by comparing the temperature of water selected by the water discharge command and the temperature of water of which discharge is limited, which was set by the user.

If the water discharge command does not correspond to a command limiting water discharge in operation S730-N, the electronic device 100 performs a water discharge operation in response to the water discharge command in operation S740.

If the water discharge command corresponds to a command limiting water discharge in operation S730-Y, the electronic device 100 performs user authentication in operation S750. Specifically, the electronic device 100 may transmit a signal requesting user authentication to the terminal 200. When the user authentication is performed in the terminal 200 in response to the signal, the electronic device 100 may receive information on the result of the user authentication from the terminal 200 and perform the user authentication. Alternatively, the electronic device 100 may perform the user authentication through at least one of the fingerprint authentication part or the password authentication part included in the electronic device 100.

The electronic device 100 determines whether the user authentication succeeded according to the result of the user authentication in operation S760.

If the user authentication succeeded in operation S760-Y, the electronic device 100 performs a water discharge operation in response to the water discharge command in operation S740.

If the user authentication failed in operation S760-N, the electronic device 100 ignores the water discharge command in operation S750. That is, the electronic device 100 may not perform a water discharge operation according to the water discharge command.

As described above, by fundamentally preventing an unintended operation of the electronic device 100 by a child, an elderly person, a pet, etc. by setting the water discharge limit information through the external terminal 200, risk of burn when using hot water and damage that may occur because of water leak due to an input of a water discharge key in the absence of the user can be removed.

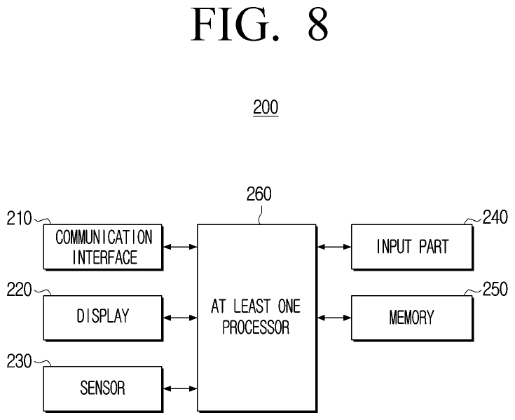

FIG. 8 is a block diagram including components of a terminal according to an embodiment of the disclosure. As illustrated in FIG. 8, the terminal device 200 may include a communication interface 210, a display 220, a sensor 230, an input part 240, memory 250, and at least one processor 260.

The communication interface 210 may include at least one circuit, and perform communication with various types of external devices (e.g., the electronic device 100). The communication interface 210 may include at least one of a Bluetooth Low Energy (BLE) module, a Wi-Fi communication module, a cellular communication module, a 3rd Generation (3G) mobile communication module, a 4th Generation (4G) mobile communication module, a 4th Generation Long Term Evolution (LTE) communication module, or a 5th Generation (5G) mobile communication module.

In particular, the communication interface 210 may transmit water discharge limit information to the electronic device 100. Also, the communication interface 210 may receive a signal requesting user authentication from the electronic device 100. In addition, the communication interface 210 may transmit information on the result of the user authentication to the electronic device 100.

The display 220 may display various type of information. In particular, the display 220 may display a screen of an application for controlling the electronic device 100. The terminal 200 may receive an input of water discharge limit information through the screen of the application. Also, the terminal 200 may display a screen for user authentication.

Meanwhile, the display 220 may be implemented as a liquid crystal display (LCD), organic light emitting diodes (OLEDs), etc. Also, the display 220 may be implemented as a flexible display, a transparent display, etc. depending on cases. However, the display 220 according to the disclosure is not limited to a specific type.

The sensor 230 may obtain various types of information related to the terminal 200. In particular, the sensor 230 may include a GPS that can obtain position information of the terminal 200, and may include various types of sensors such as a biometric sensor for obtaining biometric information of a user using the terminal 200 (e.g., a heartrate sensor, a PPG sensor, etc.), a movement sensor for detecting movements of the electronic device 200, etc.

The input part 240 may include circuitry, and the at least one processor 260 may receive a user command for controlling the operation of the terminal 200 through the input part 240. Specifically, the input part 240 may be implemented in a form of being included in the display 220 as a touch screen, but this is merely an example, and the input part 240 may consist of components such as a button, a microphone, and a remote control signal receiver (not shown), etc.

In particular, the input part 240 may receive a user input for setting water discharge limit information, and receive a user input for user authentication.

The memory 250 may store at least one instruction for controlling the terminal 200. In particular, the memory 250 may store data for the application for controlling the electronic device 100. Meanwhile, the memory 250 may include non-volatile memory that can maintain the stored information even if power supply is stopped, and volatile memory that needs constant power supply for maintaining the stored information.

In particular, the at least one processor 260 may control the overall operations of the terminal 200 by executing the at least one instruction stored in the memory 250. Specifically, if the application for controlling the electronic device 100 is executed, the at least one processor 260 may control the communication interface 210 to transmit water discharge limit information that was set according to a user input to the electronic device 100. Also, when a signal requesting user authentication is received from the electronic device 100, the at least one processor 260 may control the display 220 to display a user authentication screen through the application for controlling the electronic device 100. When the user authentication is performed through the input part 240, the at least one processor 260 may control the communication interface 210 to transmit the result of the user authentication to the electronic device 100.

Meanwhile, methods according to the various embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, the methods according to the various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: a TV).

Meanwhile, a storage medium readable by machines may be provided in the form of a non-transitory storage medium. Here, the term ‘a non-transitory storage medium’ only means that a storage medium is tangible, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

In case an instruction is executed by a processor, the processor may perform a function corresponding to the instruction by itself, or by using other components under its control. An instruction may include a code that is generated or executed by a compiler or an interpreter.

Further, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

1. An electronic device comprising:
a communication interface configured to perform communication with an external terminal;
a water discharge part configured to discharge water;
an input part configured to receive an input of a water discharge command; and
at least one processor configured to perform processing to:
receive water discharge limit information from the terminal through the communication interface,
based on receiving an input of a water discharge command through the input part, determine whether the water discharge command corresponds to a command limiting water discharge on a basis of the water discharge limit information,
based on the water discharge command corresponding to the command limiting water discharge, perform user authentication, and
based on the user authentication succeeding, control the water discharge part to perform a water discharge operation in response to the water discharge command.

2. The electronic device of claim 1, wherein
the water discharge limit information includes:
information on a water discharge limit time, and
the at least one processor is configured to perform processing to:
determine whether the water discharge command corresponds to the command limiting water discharge by determining whether a time when the water discharge command was input corresponds to the water discharge limit time.

3. The electronic device of claim 1, wherein
the water discharge limit information includes:
information on a water discharge mode for which a water discharge limit was set by a user among a plurality of water discharge modes, and
the plurality of water discharge modes include:
at least two of a purified water discharge mode, a cold water discharge mode, a hot water discharge mode, or an ice water discharge mode, and
the at least one processor is configured to perform processing to:
determine whether the water discharge command corresponds to the command limiting water discharge by determining whether the water discharge mode selected by the water discharge command corresponds to the water discharge mode for which the water discharge limit was set.

4. The electronic device of claim 1, wherein
the water discharge limit information includes:
information on a temperature of water of which discharge is limited, which was set by a user, and
the at least one processor is configured to perform processing to:
determine whether the water discharge command corresponds to the command limiting water discharge by comparing a temperature of water selected by the water discharge command and the temperature of the water of which discharge is limited, which was set by the user.

5. The electronic device of claim 1, wherein the at least one processor is configured to perform processing to:
control the communication interface to transmit a signal requesting user authentication to the terminal, and
based on the user authentication being performed in the terminal in response to the signal, receive information on a result of the user authentication from the terminal through the communication interface.

6. The electronic device of claim 1, wherein
the electronic device comprises:
at least one of a fingerprint authentication part and a password authentication part, and
the at least one processor is configured to perform processing to:
perform the user authentication through at least one of the fingerprint authentication part and the password authentication part included in the electronic device.

7. The electronic device of claim 1, wherein
the at least one processor is configured to perform processing to:
based on the user authentication failing, ignore the water discharge command and not perform a water discharge operation.

8. The electronic device of claim 3, wherein the input part includes:
a plurality of keys corresponding to the plurality of water discharge modes.

9. A control method of an electronic device, the control method comprising:
receiving water discharge limit information from an external terminal;
based on receiving an input of a water discharge command, determining whether the water discharge command corresponds to a command limiting water discharge on a basis of the received water discharge limit information;
based on the water discharge command corresponding to the command limiting water discharge, performing user authentication; and
based on the user authentication succeeding, performing a water discharge operation in response to the water discharge command.

10. The control method of claim 9, wherein
the water discharge limit information includes:
information on a water discharge limit time, and
the determining includes:
determining whether the water discharge command corresponds to the command limiting water discharge by determining whether a time when the water discharge command was input corresponds to the water discharge limit time.

11. The control method of claim 9, wherein
the water discharge limit information includes:
information on a water discharge mode for which a water discharge limit was set by a user among a plurality of water discharge modes, and
the plurality of water discharge modes include:
at least two of a purified water discharge mode, a cold water discharge mode, a hot water discharge mode, or an ice water discharge mode, and
the determining includes:
determining whether the water discharge command corresponds to the command limiting water discharge by determining whether the water discharge mode selected by the water discharge command corresponds to the water discharge mode for which the water discharge limit was set.

12. The control method of claim 9, wherein
the water discharge limit information includes:
information on a temperature of water of which discharge is limited, which was set by a user, and
the determining includes:
determining whether the water discharge command corresponds to the command limiting water discharge by comparing a temperature of water selected by the water discharge command and the temperature of the water of which discharge is limited, which was set by a user.

13. The control method of claim 9, further comprising:
transmitting a signal requesting user authentication to the terminal, and
based on the user authentication being performed in the terminal in response to the signal, receiving information on a result of the user authentication from the terminal.

14. The control method of claim 9, wherein
the electronic device includes:
at least one of a fingerprint authentication part and a password authentication part, and
the performing the user authentication includes:
performing the user authentication through at least one of the fingerprint authentication part and the password authentication part included in the electronic device.

15. The control method of claim 9, comprising:
based on the user authentication failing, ignoring the water discharge command and not performing a water discharge operation.
